(19) United States
(12) Patent Application Publication
(10) Pub. No.: US 2006/0085503 A1
(43) Pub. Date: Apr. 20, 2006

(54) Data communications system using e-mail tunnelling

(76) Inventors: William Stoye, Cambridge (GB); Paul Butcher, Cambridgeshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/515,007

(22) PCT Filed: May 20, 2003
(86) PCT No.: PCT/GB03/02144

§ 371 Date: Aug. 4, 2005

(30) Foreign Application Priority Data
May 21, 2002 (GB) 02117364

(51) Int. Cl. G06F 15/16

(52) U.S. Cl. 709/206

(57) ABSTRACT

This invention is generally concerned with data communications systems, more particularly systems for communicating between two software processes through an intervening firewall. A method of communicating data through a firewall, from a first software process on a first machine to a second software process on a second machine, the method comprising receiving data for communication at said first software process; encoding said received data as an e-mail message; sending said email message including said encoded data from said first software process to said second software process through said firewall; receiving said e-mail message including said encoded data at said second software process; decoding said encoded data in said e-mail message using said second software process; and outputting said decoded data from said second software process; and wherein said receiving at said first software process, said encoding and said sending are implemented by said first software process without user intervention; and wherein said receiving at said second software process, said decoding and said outputting are implemented bar said second software process without user intervention.

This invention is generally concerned with data communications systems, more particularly systems for communicating between two software processes through an intervening firewall.

Computer network communications employ standard protocols, the most common of which is the TCP/IP family of protocols. These protocols include file transfer (FTP), remote log in and computer mail protocols. Data communications generally operate on a client-server model, a server being a computer program or system that provides a specific service for one or more clients. In TCP/IP TCP (Transmission Control Protocol) breaks a message down into datagrams and reassembles them on receipt whilst IP (Internet Protocol) is a connectionless packet switching protocol responsible for routing the individual datagrams. Most IP traffic uses the TCP protocol although other protocols such as RDP (Reliable Data Protocol) and UDP (User Datagram Protocol) are also available. Most data communications between software processes uses TCP which provides a simple, connection-oriented protocol which hides error handling and guarantees a reliable link.

To communicate using the TCP protocol a connection must be established between a pair of sockets, one on the server process the other on the client process. The server process listens for a connection request following which a three-way handshake establishes a connection. Once a TCP connection is established it behaves, broadly speaking, like a piece of wire in which bidirectional, error-fee communication is available and in which data arrives in the same order in which it was sent. It can therefore be readily understood why the use of TCP to communicate between software processes is almost ubiquitous.

The sockets between which the TCP connection is established may be specific to the client-server processes, but a number of “well-known” sockets have also been defined for processes such as FTP (socket 21) web browsing (socket 80) and e-mail (socket 25) and many systems have server processes listening for connections to the sockets. It should be understood, however, the use of TCP/IP is not restricted to the Internet and these protocols are also used, for example, in a typical corporate network, for example, over Ethernet.

As mentioned above, socket 25 is for e-mail communication, more specifically communication using SMTP (Simple Mail Transfer Protocol). E-mail is delivered by a source machine establishing a connection to port 25 of the destination machine, which operates as the server. The SMTP is defined by RFC (Request for Comments) 821, the e-mail format is defined by RFC 822, and an extended SMTP protocol is defined in RFC 1425. Once an e-mail has been received by the server it is stored in the recipient's mailbox, typically a file on the server machine, from where it can be read using a mail browser/manager on a desktop terminal coupled to the server over a local network. The server process is sometimes called a Message Transfer Agent (MTA) and the e-mail browser/manager is sometimes called a Mail User Agent (MUA). A desktop terminal user wishing to send an e-mail composes the e-mail using the mail browser/manager, which passes it to the server to forward for delivery (alternatively the message may be composed on the server). Many e-mail systems support MIME Multipurpose Internet Mail Extensions) attachments in which binary data is encoded as text (base 64) as defined in RFCs 2045-2049. This allows message body of an e-mail to contain an “attachment” such as an image data file.

SMTP is a server machine to server machine protocol. A well-known message transfer agent using SMTP is sendmail, which runs under Unix. In a PC-based system Microsoft Exchange (Trade Mark) may be used. A commonly used mail user agent providing e-mail viewing and management is Microsoft Outlook (Trade Mark). Microsoft's Messaging API (MAPI) may be run on a desktop PC to provide e-mail communication services to applications running on the PC (Personal Computer). MAPI communicates with Microsoft's Exchange server and allows software processes to register for notification of e-mail arrival and allows software processes to send e-mails, among many other functions.

Although SMTP is the most common and popular e-mail protocol, other e-mail protocols are also employed, such as the Notes protocol for use with IBM Lotus Notes (Trade Mark). There are also proprietary e-mail protocols, such as the protocol which may be employed when, for example two Microsoft Exchange servers are talking to one another. A corporate e-mail server machine may also run POP (Post Office Protocol) server to store incoming e-mail until the receiving client is ready to accept it. Many systems employ the POP3 protocol or its replacement IMAP (Internet Message Access Protocol).

Data transmission is also becoming increasing important within mobile phone networks, and in particular within so-called 2.5G and 3G (Third Generation) networks. These 2.5G and 3G networks, are encompassed by the International Mobile Telecommunications IMT-2000 standard (www.ituint), hereby incorporated by reference. Third generation technology uses CDMA (Code Division Multiple Access) for communicating across the radio interface between a mobile station and a base station and the IMT-2000 standard contemplates three main modes of operation, W-CDMA (Wide band CDMA) direct spread FDD (Frequency Division Duplex) in Europe and Japan, CDMA-2000 multicarrier FDD for the USA, and TD-CDMA (Time Division Duplex CDMA) and TD-SCDMA (Time Division Synchronous CDMA) for China.

Collectively the radio access portion of a 3G network is referred to as UTRAN (Universal Terrestrial Radio Access Network) and a network comprising UTRAN access networks is known as a UMTS (Universal Mobile Telecommunications System) network. The UMTS system is the subject of standards produced by the Third Generation Partnership Project (3GPP, 3GPP2), technical specifications for which can be found at www.3gpp.org. These standards include Technical Specifications 23.101, which describes a general UMTS architecture, and 25.101 which describes user and radio transmission and reception (FDD) versions 4.0.0 and 3.2.2 respectively, which are also hereby incorporated by reference.

Mobile cellular communications systems such as GPRS (General Packet Radio Service) and 3G systems add packet data services to the circuit switched voice services of a 2G GSM (Group System for Mobile communications)-based system. User end equipment for data communications typically comprises a mobile station or handset, which may be referred to as a mobile terminal (MT), incorporating a SIM (Subscriber Identity Module) card. The handset may be coupled to a personal computer, sometimes referred to as Terminal Equipment (TE), by means of a wired or wireless serial connection, for example a Bluetooth link. Sometimes the handset may require a terminal adapter, such as a GSM datacard. Typically the terminal equipment communicates with the handset using standard AT commands as defined, for example, in 3GPP Technical Specification 27.007, hereby incorporated by reference.

Once a handset has attached to a GPRS network it is effectively “always on” (when switched on) and user data can be transferred transparently between the handset and an external data network. The wireless network is provided with a wireless gateway to allow a mobile device (MT or TE) to be accessed, for example via the Internet, using standard TCP/IP protocols.

It is desirable to be able to send and receive e-mails from a mobile device and many Palm Top computers and PDAs (Personal Digital Assistants) have e-mail clients and browsers. These allow an e-mail account to be set up with an e-mail address, for example self@mymobiledevice.com but this introduces problems of synchronisation in e-mails on the mobile device and e-mails on, for example, a desktop PC on a corporate network which is also used for e-mail communication. Furthermore because these two systems will have different e-mail addresses e-mails may be sent to the “wrong address”. WO 99/63709 describes a solution to this problem in which a redirector programme operating on a desktop computer redirects user-selected data items from a host system to the user's mobile device upon detecting that one or more user-defined triggering events have occurred. However further problems arise in corporate environments.

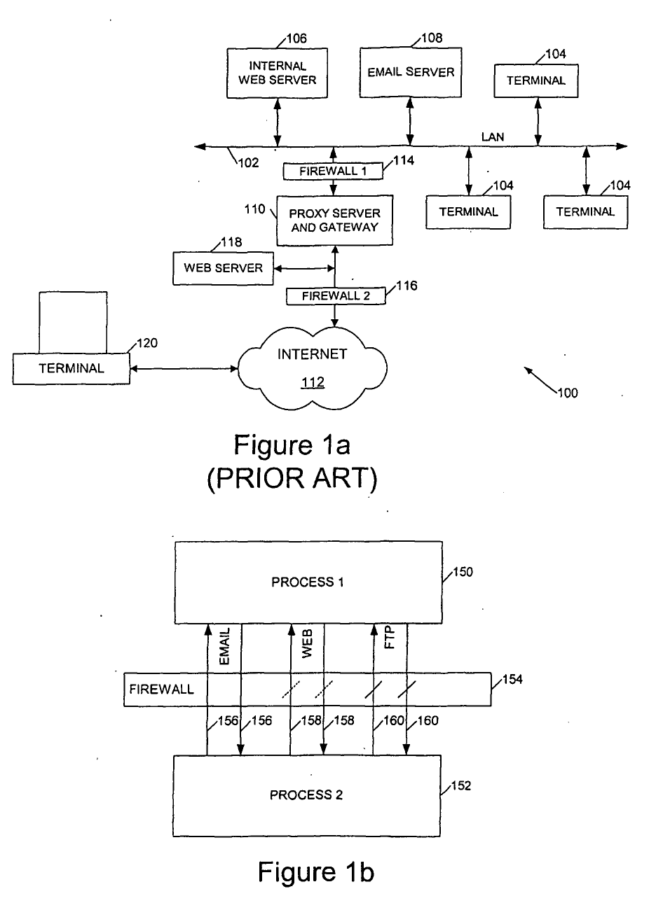

A typical (simplified) corporate network 100 is shown in FIG. 1a. A corporate LAN (Local Area Network) 102 connects a plurality of user terminals 104, typically desktop PCs, with an internal web server 106, and e-mail server 108 as described above, and a proxy server and gateway 110. Proxy server and gateway 110 provides a single connection to the outside world, and in particular to the Internet 112, to control external access to LAN 102 and to the devices attached to this network. As will be known to those skilled in the art proxy server 110 typically translates “internal” IP addresses to one or more valid “external” IP addresses and provides data caching filtering and control functions. Proxy server 110 may be referred to as a fire wall machine since one of its purposes is to masquerade to the Internet 112 as an internal client, such as one of terminals 104, substituting its IP address for a client terminal's IP address to thereby hide the client terminal from the Internet 112. Typically the corporate network will also include one or more firewalls, such as firewalls 114 and 116 to provide additional security. These may run on the proxy server machine or on separate machines. The firewalls typically perform IP packet filtering based upon packet type, source address, destination address and/or port (i.e. socket) data in each packet. Filtering may also be based upon payload data, for example to implement keyword-based access restrictions. In the example shown Firewall 116 allows controlled access to an external web server 118 and firewall 114 provides additional protection for corporate LAN 102. In this way a terminal connected to Internet 112, such as terminal 120, may be provided with limited access to external web server 118 and, for example, e-mail access to e-mail server 108 but may be denied, for example, any FTP access either to web server 118 or to any of the other elements of the corporate network.

The control provided by a firewall is conceptually illustrated in FIG. 1b in which a first software process 150 is in communication with a second software process 152 through a firewall 154. Typically 154 is set up to permit bi-directional e-mail communication 156, to provide limited web (port 80) communication 158 and to deny FTP communication 160. The precise conditions for allowing an denying access are typically set up in the firewall software 154 by a system administrator.

Many organisations' networks are connected to the public Internet via a firewall. Initially the firewall is typically configured to reject any connection attempt by default. Without any further configuration this would mean that no computer inside the firewall could connect to any computer outside, or vice-versa. All firewalls, therefore, are configured to allow certain connections under certain circumstances, and in particular most firewalls are configured to allow e-mail to pass in both directions.

Implementing a new software system inside an organisation's intranet that needs connectivity to the Internet can often require that the system administrator create a “hole” in the firewall. This is undesirable for security reasons and can also increase resistance to installing a software system.

There is therefore a need for a data communications system which can be installed to provide data communications through a firewall without needing modification to the firewall to define more allowed connection types.

According to a first aspect of the invention there is therefore provided a method of communicating data through a firewall, from a first software process on a first machine to a second software process on a second machine, the method comprising receiving data for communication at said first software process encoding said received data as an e-mail message sending said e-mail message including said encoded data from said first software process to said second software process through said firewall; receiving said e-mail message including said encoded data at said second software process; decoding said encoded data in said e-mail message using said second software process; and outputting said decoded data from said second software process; and wherein said receiving at said first software process, said encoding and said sending are implemented by said first software process without user intervention; and wherein said receiving at said second software process, said decoding and said outputting are implemented by said second software process without user intervention.

The method allows the two software processes to communicate with one another using e-mail to tunnel through the firewall to provide, so far as a user is concerned a substantially transparent data link. Because the data being transported is encapsulated within an e-mail protocol the data link is reliable in the sense that if the data arrives it is generally substantially error-free. The data link is, in some senses, less efficient than a conventional TCP connection since it typically exhibits high latency and, in addition, it is not generally possible to guarantee that data items are received in the same order as they are sent. However provided these drawbacks are tolerable embodiments of the method may be used by any software system that requires communication across a firewall, in particular where the performance characteristics of e-mail transport are acceptable.

Most organisations' firewalls are typically configured to allow a very limited set of incoming connections and a somewhat wider set of outgoing connections. Connections may be allowed or disallowed on the basis of parameters such as whether the connection is being initiated from inside or outside the firewall, whether the connection is based on UDP or TCP, the IP address of the source or destination of the connection and the like. In general it is not possible to predict how any given firewall will be configured as it typically varies from organisation to organisation depending upon the level of external access required by individuals within the organisation and the level of security required. The above described method permits a new data communications service that requires communication across the firewall to be established without requiring reconfiguration of the firewall to generate a new “hole” in the firewall. This simplifies installation of the software and allows new data communications across existing firewalls without a security audit, which is typically required when a new hole in a firewall is created. The method allows tunnelling through a firewall and thus connectivity to the Internet by using e-mail as a transport mechanism, virtually all firewalls allowing e-mails to pass through in both directions. The encoding and sending of the one or more e-mail messages is automatic as is the decoding and outputting, so that the communications link may operate without user intervention. Thus in embodiments another software process merely has to call or invoke the communications method in order to transfer data through the firewall, without relying on human intervention. In embodiments of the method the received data may be in effect packetised into a plurality of e-mail messages to be sent one after the other. The outputting of the decoded data may be an “internal” output—that is the second software process could be a communications process or subroutine of another program with an internal output to another process calling or invoking a second software process. Alternatively the second software process can output the decoded data directly to a user or to another communications system for forwarding to a further destination.

The skilled person will appreciate that the method may be used to send data in either direction through a firewall and that, in the various embodiments described below, the locations of the first and second software processes may be exchanged. The skilled person will further appreciate that the first software process may further perform the functions of the second software process and vice-versa to allow a bi-directional communications link to be implemented. More particularly, because many firewalls are responsive to the direction of traffic in determining whether or not to permit access, e-mail tunnelling may be necessary for communication in one direction only.

Where the first machine comprises a computer coupled to a network e-mail tunnelling according to the above-described method may be preferable for transporting data through the file in an inwards direction, that is towards the first machine, but some other protocol may be employed for transporting data out of the firewall, that is when sending data from the first software process to the second software process. This is because incoming data is likely to be more tightly controlled than outgoing data, and in such circumstances it may be faster to transmit data by e-mail tunnelling as described only where necessary.

The first machine may comprise a computer coupled to a network protected by the firewall and the second machine may comprise a server, such as a relay server, external to the protected network or vice-versa. The skilled person will recognise that e-mail packaging or tunnelling as described may be used for either or both of ingress (of data) to the first machine and egress from the first machine through the firewall. These uses (ingress and egress) are independent of one another and therefore the invention provides, in different but related aspects, methods, apparatus, and processing code for the use of e-mail packaging or tunnelling for data ingress and egress through a firewall separately and independently of one another, in addition to the more specific embodiments described below in which, preferably, e-mail tunnelling is used for carrying data in both directions. The external server will typically be connected to the Internet. The method then preferably includes providing the e-mail message with an e-mail destination address of the external server prior to the sending.

The outputting from the second software process may comprise sending the decoded data to a third software process on a third machine. The method may therefore include adding an identifier for the third machine or for a user of the third machine to the received data prior to the encoding. This enables the second software process to output the decoded data for forwarding to this third machine (or user), although it will be appreciated that this information could instead, for example, be included in the source address of the e-mail message sent by the first software process. In some other embodiments, the address of the third machine is computed by the second machine based on looking up the address of the first machine in a suitable database. The third machine, in a preferred embodiment comprises a mobile terminal—that is any mobile computing device including, but not limited to, a mobile phone, a wireless-enabled PDA, and a computer coupled to a mobile phone or other mobile communications device. The mobile terminal is coupled to a digital mobile communications network, which may be a digital mobile phone network as described above or some other mobile communications network, for example a Hiperlan/2 network.

In a preferred embodiment the received data is encrypted prior to the encoding and the outputting outputs encrypted decoded data. In this way the external server does not have access to the decrypted data. Preferably the data is decrypted at the third machine, that is at the mobile terminal. In many situations the mobile terminal will be periodically connected to the first software process, or at least to an encryption process used by the first software process, for example where a PDA is from time to time directly connected to, say, a desktop terminal. In these situations there is no need for the complexity of an asymmetric encryption algorithm such as PKI (Public Key Infrastructure) and it is therefore preferable to provide symmetric key encryption, for example based upon an algorithm such as the US Data Encryption Standard (DES) algorithm (FIPS-46, FIPS-47-1, FIPS-74, FIPS-81, US National Bureau of Standards) or a variant or development of this such as Triple DES (3 DES) or the NIST Advanced Encryption Standard (AES) algorithm (FIPS (Federal Information Processing Standard)-197).

As previously mentioned the e-mail message sent through the firewall will include a source and destination address, and these will not generally be encrypted. Preferably the encrypting also does not encrypt the third machine identifier, to facilitate forwarding of the encrypted data.

In a preferred embodiment of the method data is communicated from a plurality of said first software processes, running of a plurality of first machines, to the external server, from which they may be relayed on to their final destinations. This allows a single external server to provide a plurality of communications links for a corporate network.

In a preferred embodiment the data for communication by the method received at the first software process comprises an incoming e-mail message (either all of the message or, to reduce the volume of data to be communicated, only part of the message) of an incoming e-mail. Preferably header information from the incoming e-mail is also communicated using the method. In this way a said first software process running on an e-mail server or desktop terminal may be employed to forward e-mails through the external (relay) server to a mobile device for a user, transparently and without changing the incoming e-mails source or destination address. The first and second software processes may also be configured, as described above, to send data in the other direction through the firewall, that is from the second software process to the first software process, again using an e-mail tunnelling protocol, to send back, for example, e-mail control and/or manipulation data from the third machine, that is the mobile terminal or device. In this way when an e-mail is, for example, read or deleted on the mobile device the desktop or e-mail server may be automatically synchronised or updated, to perform the same act on a copy of the e-mail stored, for example, on the server.

Preferably the third machine or mobile terminal processes the data it receives to convert it to a standard e-mail data format, such as that defined in RFC 822, or any other standard format. The processed data in standard e-mail format may then be made available to any conventional e-mail application, for example for reading and manipulation by a user. Preferably the data reception and conversion process is implemented on the third machine or mobile terminal as a protocol driver, which is easy to distribute and install to provide functionality for receiving (and/or sending) e-mail data according to the above-described method, at the third machine, using an unmodified e-mail front end (apart, that is, from configuration information which may be necessary to set up the e-mail front end to use the protocol driver).

In a related aspect the invention provides a method of establishing a data communication link through a firewall which would otherwise block the link, without requiring a modification to said firewall, the method comprising establishing a first software process on a first machine, establishing a second software process on a second machine, and establishing said data communication link by communicating data from said first to said second software process by a method comprising receiving data for communication at said first software process, encoding said received data as an e-mail message, sending said e-mail message including said encoded data from said first software process to said second software process through said firewall, receiving said e-mail message including said encoded data at said second software process; decoding said encoded data in said e-mail message using said second software process; and outputting said decoded data from said second software process; and wherein said receiving at said first software process, said encoding and said sending are implemented by said first software process without user intervention; and wherein said receiving at said second software process, said decoding and said outputting are implemented by said second software process without user intervention.

The invention also provides processor control code to, when running, implement a first software process to establish a data communication link with a second software process through a firewall which would otherwise block the link, the code comprising code to, without user intervention, receive data for communication at said first software process, encode said received data as an e-mail message, and pass said e-mail message to an e-mail handling process to send said e-mail message including said encoded data from said first software process to said second software process through said firewall.

The processor control code does not itself need to send the e-mail since the e-mail message may be sent by instructing a messaging application or by notifying an exchange server; similarly the message itself need not be passed to the e-mail handling process as a pointer to the message or its file name will generally be sufficient.

The code preferably provides the e-mail message with an e-mail destination address of the above-described external server, and may further code to add an identifier for a final destination of the received data, such as the above-described third machine, or at least a destination for the external server to use in re-transmitting the data. In one embodiment this identifier has a format which does not correspond to a valid e-mail address format.

The code may further comprise code for encrypting the received data prior to encoding it, preferably, as above, by means of a symmetric key cryptographic technique. Again, however, preferably the destination identifier is not encrypted.

The code may further include code to, without user intervention, receive an e-mail message including received encoded data through the firewall from the second software process; decode the received encoded data; and output the decoded received encoded data. In this way the first software process can both send and receive data using the e-mail tunnelling protocol. The data sent in one, or both directions may comprise at least partial data for an e-mail, preferably at least part of the message, more preferably including the header, and most preferably, (depending upon the bandwidth) the entire e-mail. The back hall link may be used to carry e-mail manipulation data for example to synchronise e-mail status data stored on an e-mail server and on a mobile device.

In a related aspect the invention provides data communication apparatus for implementing a first software process to establish a data communication link with a second software process through a firewall which would otherwise block the link, the apparatus comprising program memory storing the above-described processor control code, a processor coupled to said program memory for operating in accordance with said processor control code, and a communications interface for communicating said e-mail message.

In another related the invention provides a method of implementing a first software process to establish a data communication link with a second software process through a firewall which would otherwise block the link, the method comprising, receiving data for communication at said first software process, encoding said received data as an e-mail message, and passing said e-mail message to an e-mail handling process to send said e-mail message including said encoded data from said first software process to said second software process to said second software process through said firewall, and wherein said receiving at said first software process, said encoding and said sending are implemented by said first software process without user intervention.

The invention also provides processor control code to, when running, implement a second software process to establish a data communication link with a first software process through a firewall which would otherwise block the link, the code comprising code to, without user intervention receive an e-mail message, including encoded data, from said first software process, decode said encoded data in said e-mail message, and output said decoded data.

The e-mail message may be received from, for example a mail server or message transfer agent. Preferably the second software process is implemented in an intermediate machine, such as the above-described external server, and preferably this intermediate machine operates as a relay server. Thus the decoded data may be provided with a destination beyond the intermediate machine, specified by a destination identifier within the encoded data, and the decoding may then decode and/or extract this destination identifier. In effect the intermediate machine or relay server is provided primarily as a receiver of e-mails since a machine at the destination may not necessarily always be able to accept e-mails. For example where the destination machine is a mobile phone or PDA without a permanent Internet connection the data may be queued at the intermediate machine and forwarded when the destination machine is able (or ready) to accept the data, for example, when it is switched on and attached to a mobile communications network. The code may therefore include code to detect when the destination machine is ready to accept data, and to output the decoded data dependent upon the result of this detection. This detection may consist of attempting communication with the machine at said destination, and waiting for a reply or a timeout in order to determine the result Additionally or alternatively the destination machine may contact the server to check for any waiting mail under control of a timer, or at the explicit request of the mobile user. In some embodiments, the intermediate server may alert the mobile device that mail is waiting by some alternative means such as by an SMS message.

Preferably the decoded data comprises encrypted data to reduce the risk of unauthorised interception of data carried by the link. Preferably both the e-mail message addresses (source and/or destination) and the destination identifier are left unencrypted, however, to facilitate data reception and processing by the intermediate machine and data forwarding to the destination machine.

Again, preferably the processor control code comprises code to implement a plurality of the second software processes for handling data sent from a corresponding plurality of said first software processors and, preferably, for sending received data on to a corresponding plurality of destination machines. Again, preferably, the processor control code comprises additional code for transmitting data to a said first software process, to enable bi-directional communications. This code may comprise code to receive data for communication at a said second software process; encode this received data as an e-mail message; and pass this e-mail message to an e-mail handling process for sending to a said first software process, on the far side of a firewall.

As before, in one embodiment the communication link is used to send e-mail data, that is a partial or complete e-mail message, optionally but preferably including header data.

In a related aspect the invention also provides data communicating apparatus for implementing a second software process to establish a data communication link with a first software process through a firewall which would otherwise block the link, the apparatus comprising program memory storing the above-described second software process processor control code, a processor coupled to said program memory for operating in accordance with said processor control code, and a communications interface for receiving said e-mail message including encoding data.

The invention further provides a method of implementing a second software process to establish a data communication link with a first software process through a firewall which would otherwise block the link, the method comprising receiving an e-mail message, including encoded data, from said first software process, decoding said decoded data in said e-mail message, and outputting said decoded data.

The invention also provides processor control code to, when running, implement a third software process to establish a data communications link, via an intermediary second software process, with a first software process through a firewall which would otherwise block the link, said firewall being located between said first and second software processes, the code comprising code to send an identifier to said second software process; receive data from said second software process, said received data comprising data defining an e-mail header and at least partial e-mail message data; reconstruct an e-mail comprising said at least partial e-mail message from said received data; and notify an e-mail user interface of the availability of said reconstructed e-mail.

The code may include code to decrypt the received data prior to its reconstruction, preferably using symmetric key decryption. Advantageously the reconstructed e-mail has a standard e-mail data format, and the third software process comprises a protocol driver. In this way e-mails can be received and/or sent and/or otherwise manipulated using a conventional e-mail application, for example a Microsoft (Trade Mark) application such as provided with the Pocket PC operating system. By providing a protocol driver for an otherwise unmodified e-mail front end mobile e-mail functionality may be implemented on many off-the-shelf commodity PDAs, without being restricted to any one particular hardware platform or operating system. This skilled person will appreciate that this arrangement need not be restricted to the use of any particular mobile terminal or PDA operating system, this being an advantage of implementation of the process as a protocol driver.

In a further related aspect the invention provides a method of implementing a third software process to establish a data communications link, via an intermediary second software process, with a first software process, through a firewall which would otherwise block the link, said firewall being located between said first and second software processes the method comprising sending an identifier to said second software process; receiving data from said second software process, said received data comprising data defining an e-mail header and at least partial e-mail message data; reconstructing an e-mail comprising said at least partial e-mail message from said received data; and notifying an e-mail user interface of the availability of said reconstructed e-mail.

The invention also provides data communications systems operating in accordance with the above methods and/or incorporating the above processor control code and/or comprising the above-described sets of data communications apparatus.

The above-described processor control code may be provided on a data carrier or storage medium such as a hard or floppy disk, ROM or CD-ROM, or on an optical or electrical signal carrier, for example via a communications network. The processor control code may comprise program code in any conventional programming language such as Java, C and the like. The methods implemented by the code may be implemented as either client or server processes on either a single machine or distributed over a plurality of machines. Aspects of the invention are particularly suited to implementation over a communications network such as the Internet, an intranet or an extranet and, the communications link may include a wireless link such as a Bluetooth (Trade Mark) link or wireless LAN link. Embodiments of the invention may be implemented on general purpose computer systems using appropriate software.

These and other aspects of the invention will now be further described by way of example only with reference to the accompanying figures in which:

FIG. 1a and 1b show respectively, a typical corporate computer network with a connection to the Internet, and operation of a firewall;

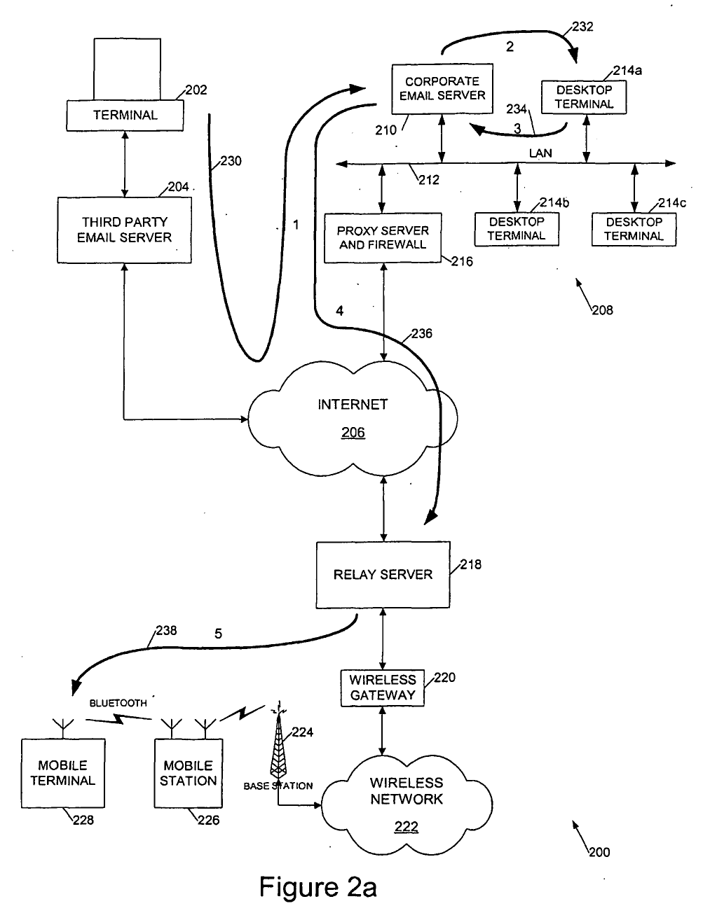

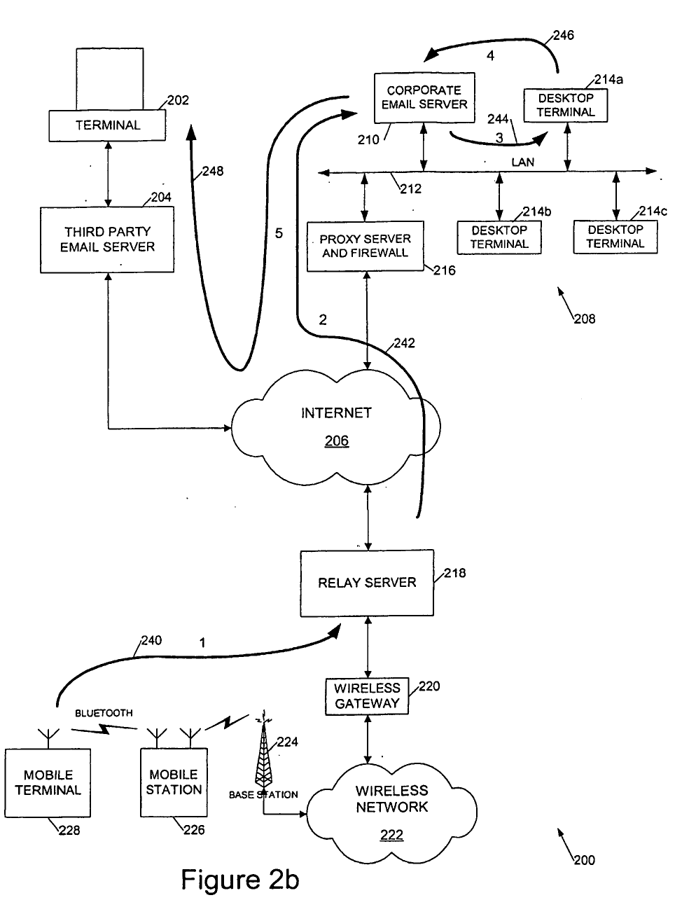

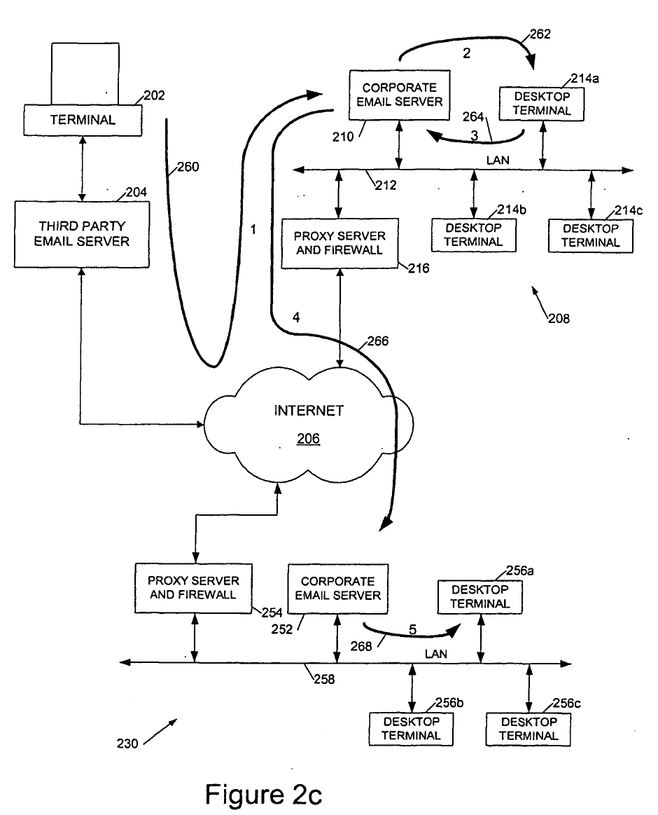

FIGS. 2a to 2c show information flows in firewall tunnelling systems according to embodiments of the present invention when, respectively, e-mail is sent from a third party to a mobile device via a corporate network with a firewall, e-mail is sent from a mobile device to a third party via a corporate network with a firewall, and e-mail is sent between user terminals of two corporate networks both with firewalls;

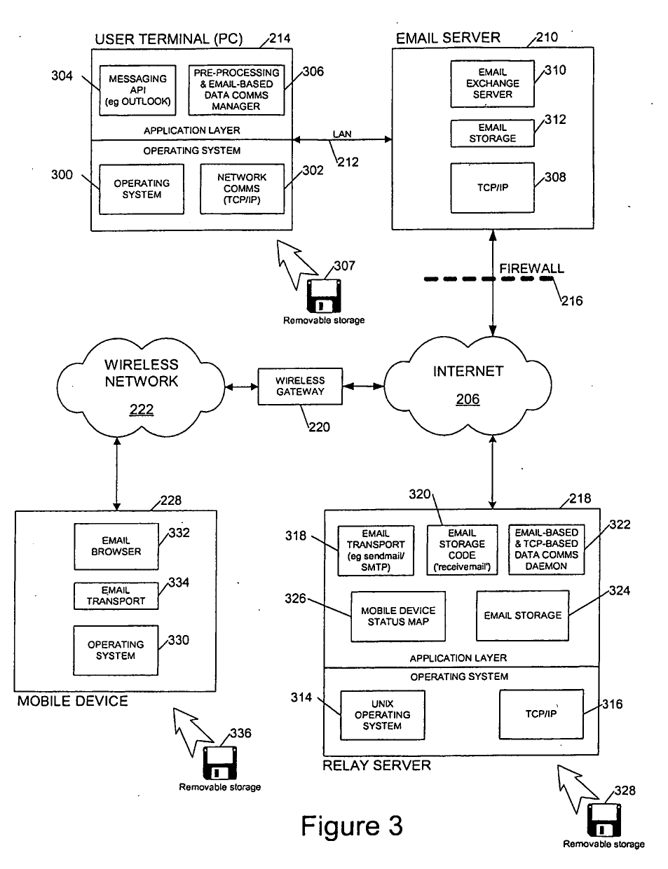

FIG. 3 shows a block diagram of a firewall tunnelling system;

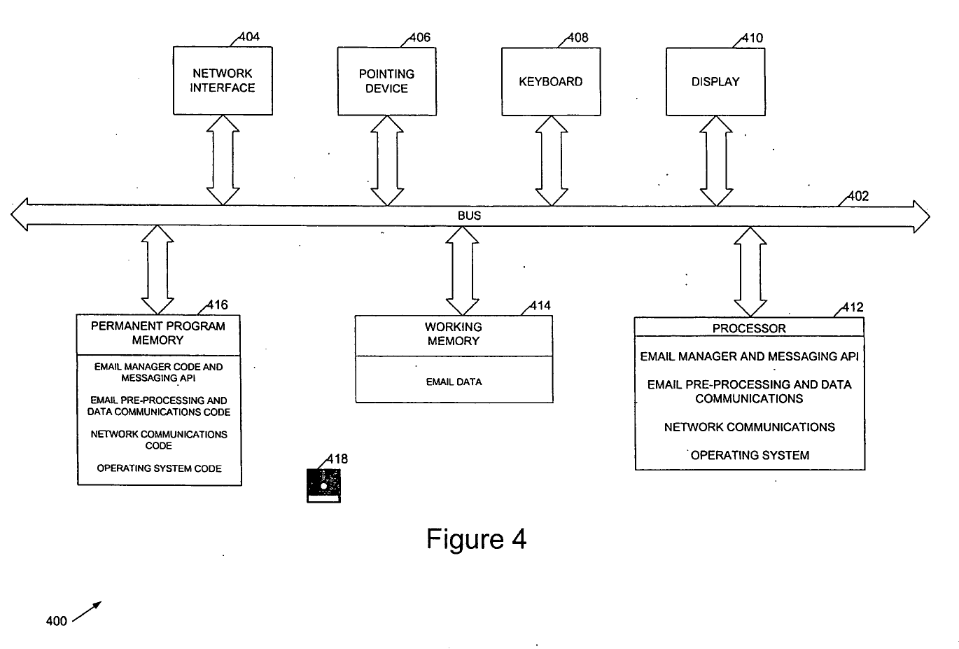

FIG. 4 shows a general purpose computer suitable for use for a firewall tunnelling communication link;

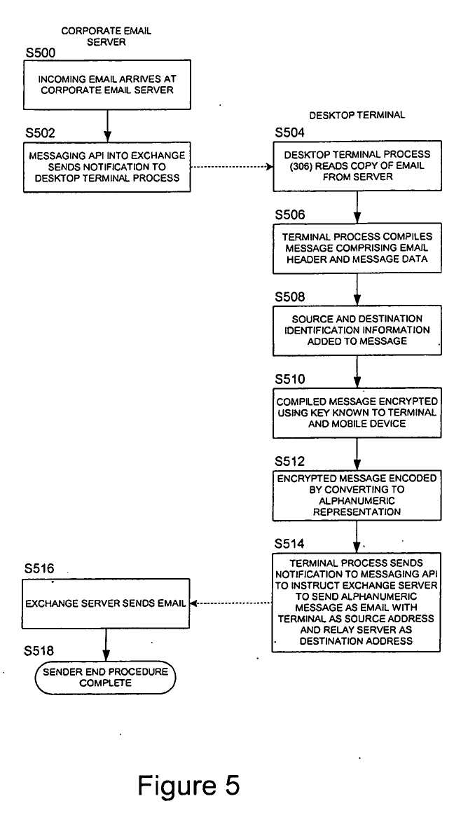

FIG. 5 shows a flow diagram of a user terminal process for establishing a data communications link through a firewall;

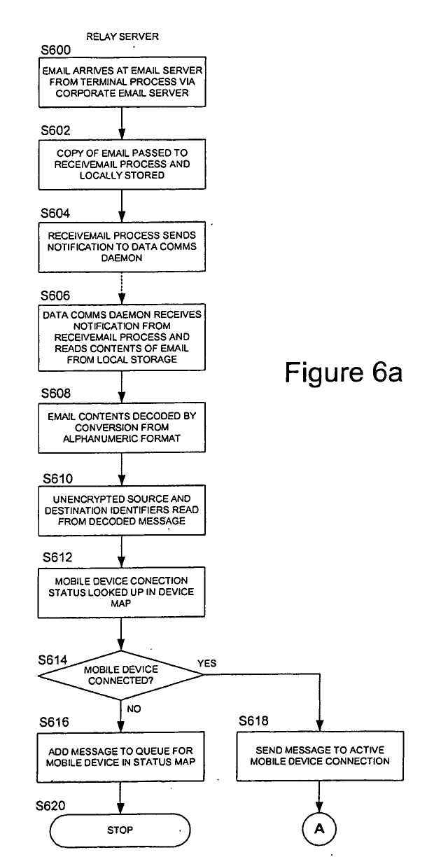

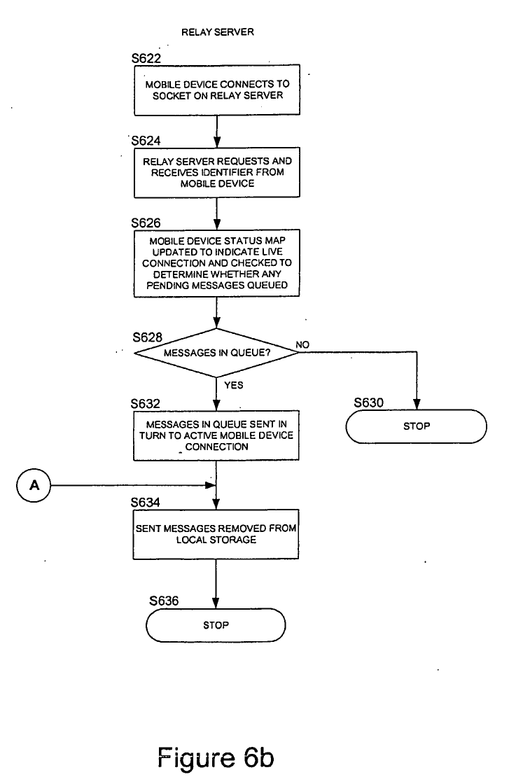

FIGS. 6a and 6b show a flow diagram of a relay server process for establishing a data communication link through a firewall; and

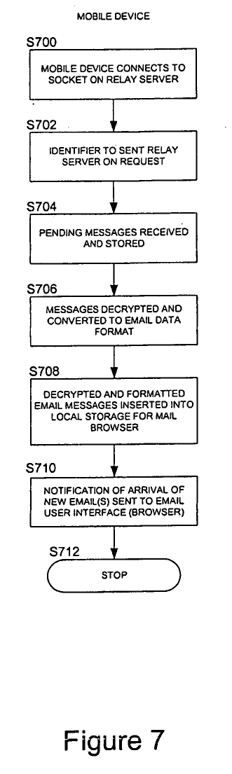

FIG. 7 shows a flow diagram of a mobile device process for receiving data tunnelled through a firewall.

Referring now to FIG. 2a this shows information flow in a firewall tunnelling system 200 embodying an aspect of the present invention when an e-mail is sent from a third party terminal 202 via a third party e-mail server 204, a corporate e-mail server 210 of a corporate network 208, and the Internet 206 to a mobile terminal or device 228.

Corporate computer network 208 comprises, as well as corporate e-mail server 210, a plurality of desktop terminals 214a, b, c, typically desktops PCs, and proxy server and firewall 216; these components are all connected together by LAN 212. A corporate network will typically comprise other components but, for simplicity, these are not shown. A relay server 218 is connected to the Internet 206 and also to a wireless gateway 220 to a wireless network 222. In some arrangements the relay server may be connected within the mobile network service provider's network rather than directly connected to the Internet. Wireless network 222 may comprise, for example a digital mobile phone network providing data communications. The wireless network 222 has a plurality of base stations such as base stations 224 to enable communication with a plurality of mobile stations, for example mobile phones such as mobile station 226. In this way mobile station 226 is provided with data communication facilities coupling the mobile station to the Internet or, in this embodiment, to relay server 218. When the mobile station 226 is attached to the wireless network 222 and enabled for data communications it is provided with an IP address, and to the outside world, simply appears as a device with which TCP/IP communications may be conducted. In the specific embodiment illustrated in FIG. 2a mobile station 226, for example a GPRS mobile phone, has a radio (Bluetooth) link to an associated mobile terminal 228, for example a Bluetooth-enabled palm top or PDA.

Consider a user of one of desktop terminals 214. The user's e-mail resides on corporate e-mail server 210 within the firewall 216 and the user normally retrieves their e-mail from a terminal (PC) such as terminal 214a also located within the firewall. Arrow 1 230 shows the flow of information when e-mail from terminal 202 is sent by third party e-mail server 204, located outside the firewall, to the user.

The e-mail reaches the corporate mail server 210 through the firewall which has been configured to allow incoming e-mail. Software running on the user's terminal 214a retrieves the e-mail from the corporate mail server (Arrow 2 232) and then a process running on terminal 214a creates what may be termed a “protocol e-mail” containing an encoded representation of the original message. This process then instructs the corporate e-mail server 210 (Arrow 3 234) to send the protocol e-mail to relay server 218 located outside the firewall. This protocol e-mail reaches the relay server 218 through the firewall (Arrow 4 236) because the firewall has been configured to permit outgoing e-mail. The relay server 218 receives the protocol e-mail, extracts the information contained within it, and creates a conventional TCP connection to software running on the user's mobile terminal or PDA 228. The contents of the original e-mail from the third party are then forwarded over this connection (Arrow 5 238).

Communication through the firewall is also possible in the reverse direction, as illustrated in FIG. 2b. In FIG. 2b like elements to those of FIG. 2a are indicated by like reference numerals.

In FIG. 2b the user creates and sends an e-mail using conventional e-mail user software running on mobile terminal or PDA 228. A software process running on mobile terminal 228 detects this action and sends the details of the new e-mail to the relay server 218 over a conventional TCP connection (Arrow 1 240). The relay server 218 then creates a protocol e-mail containing a coded representation of the user's e-mail and sends this over Internet 206 and through firewall 216 to the corporate e-mail server 210 (Arrow 2 242), where it is passed to desktop terminal 214a (Arrow 3 244). Here the information contained within the protocol e-mail is extracted and the e-mail, which comprises the contents of the e-mail on a software process running on desktop 214a then creates a new conventional e-mail containing the information extracted from the protocol e-mail and instructs (Arrow 4 246) the corporate e-mail server 210 to send it. This new e-mail is then sent to its destination (Arrow 5 248), for example terminal 202 via third party e-mail server 204, in the normal way. This new e-mail comprises the contents of the user's original e-mail sent from mobile device 228 and has a destination as specified by the user when the e-mail was created using the mobile terminal. A message sent out this way may be substantially indistinguishable from one sent manually by the user from a desktop terminal 214. Transmission to a mobile terminal may sometimes be delayed, for example when the mobile terminal is not connected to the wireless network.

Although in both the foregoing examples the “protocol e-mail” is created on desktop terminal 214a and, conversely, information is extracted from the protocol e-mail by a process running on terminal 214a, the skilled person will appreciate that these software processes could equally reside on corporate e-mail server 210.

Still referring to FIG. 2b, in another example the user reads and deletes an e-mail using conventional e-mail browser software running on mobile terminal 228. In this case, again software on mobile terminal 228 detects this action and sends data representing this action via wireless network 222 to relay server 218 (Arrow 1 240). The relay server 218 then, as before, creates a protocol e-mail, but in this example the protocol e-mail contains a coded representation of the delete notification. The relay server 218 then sends (Arrow 2 242) this e-mail to the user's e-mail address. The protocol e-mail reaches the corporate e-mail server 210 through the firewall 216 which has been configured to permit incoming e-mail.

A software process on the user's terminal 214a is notified of the arrival of the protocol e-mail by the corporate e-mail server 210, and this software process retrieves (Arrow 3 244) the protocol e-mail, decodes the protocol e-mail (to extract the delete notification), and then deletes the protocol e-mail. As protocol e-mails are deleted as soon as they arrive they are not visible to the user. Since the e-mail is recognised as a protocol e-mail it is not forwarded back to the mobile terminal 228 as a third party e-mail would be. The software process then instructs (Arrow 4 246) the corporate e-mail server to delete the e-mail according to the delete notification received from mobile terminal 228, thus automatically synchronising the mobile terminal 228 to the corporate e-mail server 210. It will be appreciated that other e-mail manipulation instructions may be sent from terminal 228 to e-mail server 210 or from desktop terminal 214 via server 210 to mobile terminal 228 in a corresponding manner.

Thus a representation of e-mails on corporate e-mail server 210 may be held on mobile terminal 228, these e-mails preferably mirroring those on e-mail server 210, and the two sets of e-mails may be automatically synchronised. The user may thus be provided with a single e-mail address even though e-mails are being received, read, deleted and otherwise manipulated at mobile terminal 228 and desktop 214, actions on either terminal affecting the e-mails accessed by both terminals. To the user the effect is of making the fixed desktop terminal mobile since a single e-mail address is maintained and e-mail manipulations and responses formed using either terminal are automatically updated so that the user has substantially the same logical (rather than physical representational) view of their e-mails from either terminal. Although this will not be the case immediately after the mobile terminal 228 has been switched on after a long period of disconnection, the system can be configured to automatically synchronise upon or soon after switch on and data communications attachment to a relevant wireless network.

The above-described techniques do not depend upon the use of any particular e-mail protocol, such as SMTP, for communications with the corporate e-mail server 210 either with third parties across firewall 216. However in a typical installation, as will be described in more detail below, the desktop terminal comprises a PC which communicates with corporate e-mail server 210 by means of Microsoft's Messaging API (MAPI) and the server 210 sends and receives e-mail using MSTP. This is not essential, however, and it is merely necessary that the firewall 216 is configured to permit single or preferably bi-directional communication using which ever protocol the e-mail server uses.

Broadly speaking the function of relay server 218 is to provide a machine which is substantially always on (or connected to Internet 206) and which can therefore act as a substantially permanent entity for receiving and/or sending e-mails. This is advantageous since a wireless-connected mobile station may be switched off or in an area of poor or non-existent wireless network coverage. However, for example, two communicating computer systems both have a permanent Internet connection the relay server may be dispensed with.

FIG. 2c shows an example of a system which corporate e-mail server 210 is in communication with a second corporate computer network 250 including a second corporate e-mail server 252. Like network 208, corporate network 250 includes a proxy server and firewall 254 behind which corporate e-mail server 252 is located. Again, like network 208, network 250 has a plurality of desktop 256a-c and elements of the network are interconnected by a LAN 258. Broadly speaking corporate e-mail server 252 performs the functions of relay server 218 and one or more of the desktop terminal 216 perform the functions of mobile terminal 228. Thus, broadly speaking, the system of FIG. 2c operates similarly to that of FIG. 2a and respective arrows 260, 262, 264, 266 and 268 of FIG. 2c corresponds to arrows 230, 232, 234, 236, 238 of FIG. 2a.

Referring now to FIG. 3, this shows a block diagram illustrating a system such as that shown in FIG. 2a in greater detail. Again, like elements to those of FIG. 2a are indicated by like reference numerals.

User terminal 214 has an operating system comprising operating system code 300 and including network communications code 302, in this embodiment for TCP/IP communications. Applications software installed on terminal 214 includes Microsoft Outlook (trade mark) or some other Messaging API 304. Also installed on terminal 214 is e-mail pre-processing and e-mail-based data communications code 306, preferably for bi-directional communication using what have been termed above as “protocol e-mails”. Terminal 214 also stores an (IP) address for relay server 218. In operation the data communications code 306 registers with the MAPI code 304 for notification of arrival of e-mails, to send e-mails, and for other e-mail manipulation functions.

It will be understood that the data communications code 306 (and the relay server address) could be installed on the e-mail server 210 or on some other machine or server. Installation of the code on either an existing or a dedicated server is preferred in some environments as, for example, a single such server may then serve a plurality of desk top terminals which may or may not themselves have a portion of the data communications code installed on them. The data communications code 306, or other code in terminal 214, may be provided on a removable storage medium, such as disk 307.

The e-mail server 210 is connected to terminal 214 by LAN 212. In a conventional manner, e-mail server 210 includes TCP/IP code 308, an e-mail server 310 such as Microsoft Exchange (trade mark) and local e-mail storage 312. The skilled person will understand that although e-mail code 310 is termed a server, in fact it behaves as a client when sending to another server. As previously described, e-mail server 210 is connected to Internet 206 via firewall 216.

The relay server 218, in the illustrated embodiment, has a Unix or Unix variant operating system 314 (although other operating systems such as Windows (Trade Mark) could also be employed) and TCP/IP communications code 316. Also installed on relay server 218 is conventional e-mail transport code 318, for example based upon sendmail, as well as e-mail storage code 320 (here termed “receivemail”) and a Unix Daemon 322 providing protocol e-mail-based and TCP-based data communications. The receivemail code 320 communicates between e-mail transport code 318 and the data communications code 322. Relay server 218 also provides local e-mail storage 324, typically as files on a hard disk, and a mobile device status map data structure 326.

Data structure 326 comprises a set of mobile device (or PDA) identifiers. Each mobile device identifier is associated with a list of pending e-mails for that mobile device (which may be a blank list) and with a flag indicating whether or not a connection to the identified mobile device is active. Part or all of the relay server code, such as receivemail code 320 and/or data communications code 322 and/or data structure 326 may be provided on a persistent, optionally removable storage medium, as illustrated by disk 328.

Relay server 218 is coupled, via Internet 206, wireless gateway 220 and wireless network 222 to mobile device 228. Mobile device 228 includes a mobile device operating system 330 and a conventional e-mail browser/client 332. For example, the Pocket PC 2002™ operating system includes an e-mail client called Pocket (Outlook) Inbox with configurable connections for POP and IMAP servers. In the present arrangement, however, mobile device 228 includes e-mail transport code 334, implemented as a protocol driver for Pocket Inbox and configured for communicating with data communications code 322 on relay server 218. Transport code 334 is configured to interface with a Microsoft software interface into their e-mail application for attaching a new transport layer. However the system is not dependent upon any particular PDA or hardware platform and in other embodiments different operating systems, such as PalmOS™ may be employed. Once e-mail transport protocol driver code 334 is installed for use with Pocket Inbox it appears as an additional option with POP and IMAP and, as far as a user is concerned, it may be selected similarly to the other options. In this way e-mails may be sent from relay server 218 to the e-mail browser 332 of mobile device 228. E-mail browser 332 provides conventional e-mail manipulation functions such as e-mail retrieve and display, e-mail send, e-mail delete and, normally, means for modifying settings such as flag settings, priority settings and the like.

Some or all of the code for mobile device 228, and in particular e-mail transport 334, may be provided on a removable storage medium, illustrated by disk 336. In practice PDA software is usually distributed on a CD and installed while the PDA is in a docking cradle attached to a PC. A single install, either from a CD or from the Internet, may install software both on the desktop PC and on an attached PDA (in docking cradle at the time).

Referring now to FIG. 4, this shows a general purpose computer system 400 suitable for use as user terminal 214, e-mail server 210, relay server 218 or, in portable form, mobile device 228, As illustrated the computer system is configured for use as a user terminal such as terminal 214. The computer has a data and address bus 402 connecting a network interface 404, a pointing device 406, such as a mouse, a keyboard 408 and a display 410. Also coupled to bus 402 is working memory 414, such as RAM, here shown storing e-mail data, and permanent program memory 416, for example comprising non-volatile storage such as EPROM, Flash, Flash RAM or a hard disk. Program memory 416 stores the operating system code 300, the network communications code 302, the MAPI code 304 and the data communications management code 306 and, when not included in MAPI code 304, an e-mail browser. Part or all of this code may be provided on a carrier medium such as a disk 418. A processor 412 is also coupled to bus 402 to implement the operating system, network communications, e-mail pre-processing and data communications, messaging API and e-mail management.

Referring now to FIG. 5, this shows a flow chart of software processes operating on corporate e-mail server 210 and a desk top terminal 214 for handling an incoming third party e-mail such as is shown, for example, in FIG. 2a.

At step S500 the incoming e-mail arrives at the corporate e-mail server and, at step S502, the messaging API into MS Exchange sends a notification of e-mail arrival to desk top terminal process 306. In other embodiments, the desk top process may instead be running on the corporate e-mail server or on another server machine.

The desk top terminal data communications process 306 reads a copy of the e-mail from the corporate e-mail server 210, at step S504. The terminal data communications process then, at step S506, compiles or packages the e-mail into a message containing, preferably, both the e-mail message body and the e-mail header including date, subject, priority, source and destination address information. To this message is then added, at step S508, a source and destination identifier.

In one embodiment, the source identifier is the e-mail address of the desk top terminal, for example user@corporation.com and the destination identifier comprises an identifier of the user's mobile device. In one embodiment this is simply a modified version of the user's e-mail address, with the “@” symbol replaced by double quotes, for example user”corporation.com. Thus the identifier of the mobile device is not a valid e-mail address, to avoid confusion, but can be generated from the user's address (or vice versa). It will be appreciated that with this arrangement there is no need to send both a source and destination identifier since one can be generated from the other.

At step S510 the compiled message, but preferably not the source and destination identifiers, is encrypted. In many applications, the mobile device or PDA will be periodically docked with the desk top terminal, that is directly connected using a serial cable or wireless link. This allows the mobile device and desk top terminal to securely share a key, making computationally expensive asymmetric public key cryptographic algorithms unnecessary. Instead symmetric algorithms relying on a shared secret key, such as the NIST Advanced Encryption Standard Algorithm mentioned above may be employed. Such algorithms nonetheless provide a high degree of security, the advanced encryption standard for example having a 128 bit key length.

At step S512 the encrypted message is encoded by converting it to an alphanumeric representation, for example by mapping groups of bits onto ASCII or other characters. Then, at step S514, the terminal data communications process 306 contacts the exchange server 310, via MAPI 304, to request that the encrypted, encoded message is sent as an e-mail to relay server 218. The destination address of the e-mail is therefore given as the address of the relay server (which is known to the terminal process) and, preferably, the source address is given as the address of the desk top terminal. The exchange server process 310 then, at step S516, sends the e-mail to relay server 218 and, at step S518, the sender end procedure then stops.

It will be appreciated that neither the outgoing “protocol e-mail” nor the unencrypted (but encoded) source and destination identifiers disclose the true source address and destination address of the original, third party incoming e-mail. This is because, as can be appreciated from the foregoing discussion, the source and destination of the original e-mail are part of the encrypted data which, as will be seen below, remains encrypted as it passes through the relay server and is only decrypted once it has finally arrived at the mobile device.

Referring next to FIG. 6, this shows a flow diagram of software processors operating on the relay server 218.

Initially, at step S600, the “protocol e-mail” arrives at the relay server e-mail transport server 318 from the data communications process 306, via e-mail exchange server 310 and the Internet 206. On arrival a copy of this incoming protocol e-mail is passed to e-mail storage process 320 (here called “receivemail”) which locally stores the incoming e-mail in e-mail storage 324 (step S602). The receivemail process 320 then sends a notification to the data communications process 322, at step S604. The data communications process 322 then takes over at step S606.

At step S606 data communications process 322 receives notification from the receivemail process 320 and reads the contents of the incoming protocol e-mail from local storage 324. The contents of this e-mail, that is the e-mail message, is then decoded at step S608, converting the message back from an alphanumerical format into binary data. This binary data includes unencrypted source and destination identifiers, as described above, which at step S610 are read from the decoded message. The remainder of the message, however, is left encrypted.

The destination identifier identifies the mobile device associated with the desk top terminal from which the protocol e-mail was sent. Thus, at step S612, the connection status of the identified destination mobile device is looked up in mobile device status map 326, in particular to determine whether or not there is an existing (active) connection to the destination mobile device (step S614). If there is no active connection to the mobile device, at step S616, the message is added to the queue for the mobile device in status map 326. Since the e-mail has already been stored, adding the message to the queue can be achieved by adding a pointer to the message to a list of pending e-mails associated with the destination mobile device identifier. The process then stops at step S620. If, on the other hand, the destination mobile device does have an active connection to the data communications process 322, at step S618 the decoded binary message is sent to the destination mobile device using the active (TCP/IP) connection. The sent message is then removed (deleted) from local storage 324 (step S634) and the procedure halts at step S636. Preferably at step S614 the procedure checks not only whether the mobile device is connected but also whether or not the queue is empty. This second condition prevents new messages arriving just as the queue is being emptied from overtaking old ones, which is undesirable.

The procedure by which a mobile device attaches to the data communications process 322 to provide an active connection is shown in steps S622 to S632. At step S622 a mobile device connects to a socket on relay server data communications process 322 which is listening for an incoming connection request. Then, at step S624, the data communications process 322 requests, and receives, an identifier from the just-connected mobile device. Once the identifier has been received mobile device status map 326 is updated to indicate that an active connection to the identified mobile device is available and a check is made to determine whether there are any pending messages for the just-connected mobile device (step S626). If, at step S628, there are no messages in the queue for the mobile device, the procedure halts at step S630. If there are messages to be sent then, at step S632, these messages are sent sequentially to the mobile device, preferably oldest first. The procedure then continues, as before, at step S634, the sent messages being deleted from the local e-mail storage 324. The primary function of local e-mail storage 324 is to provide a queue should a mobile device be out of contact. Generally speaking it is not necessary to queue messages arriving from a mobile device since the e-mail server for the destination desk top terminal will generally be “always on”, that is always connected. However, an additional benefit of e-mail storage 324 is that it provides a backup facility in case, for example, of power failure.

The procedure for the mobile terminal to receive the messages is shown in FIG. 7.

At step S700, the mobile device connects to a socket on relay server communications process 322 and at step S702, in embodiments in response to a request from the relay server, sends the server its mobile device identifier. The mobile device then, at step S704, receives any pending messages from the relay server and stores these locally. The received message or messages are then decrypted, at step S706, using the secret key known to both the mobile device and the associated desk top terminal, and converted back to an e-mail data format. The decrypted and suitably formatted e-mail message or messages are then, at step S708, inserted into local storage for mobile device mail browser 332. At step S710, notification of the arrival of new e-mail is then sent to the e-mail browser (possibly indirectly via an intermediate software process) which can then alert the user to new incoming mail. The process then halts at step S712.

The e-mail browser 332 provides a user interface which allows a user to read, manipulate, create and reply to e-mails in a conventional manner. Preferably the connection to the relay server is left open to facilitate reception of further e-mails as they arrive. Data representing such e-mail manipulations and/or data representing outgoing e-mails from the mobile device may be sent to the relay server over the open TCP/IP connection. This data may then sent through the firewall 216 back to the user's desk top terminal using the same “protocol e-mail” tunnelling techniques as described above. Broadly speaking, the above described process is simply reversed to send data in the opposite direction and, for conciseness, the description will not be repeated. However, the skilled person will appreciate that, as mentioned above, for communications originating from the mobile device the relay server does not need to maintain a queue since the e-mail server supporting the desk top terminal to which the data is directed will in general be substantially always connected.

No doubt many other effective alternatives will occur to the skilled person and it will be understood that the invention is not limited to the described embodiments and encompasses modifications apparent to those skilled in the art lying within the spirit and scope of the claims appended hereto.

1. A method of communicating data through a firewall, from a first software process on a first machine to a second software process on a second machine, the method comprising:
receiving data for communication at said first software process;
encoding said received data as an e-mail message;
sending said e-mail message including said encoded data from said first software process to said second software process through said firewall;
receiving said e-mail message including said encoded data at said second software process;
decoding said encoded data in said e-mail message using said second software process; and
outputting said decoded data from said second software process;
and wherein said receiving at said first software process, said encoding and said sending are implemented by said first software process without user intervention;
and wherein said receiving at said second software process, said decoding and said outputting are implemented by said second software process without user intervention.

2. The method as claimed in claim 1 wherein said method of communicating data through a firewall establishes a substantially user-transparent data communication link between said first and second software processes.

3. The method as claimed in claim 1 wherein said first machine comprises a computer coupled to a network protected by said firewall, and wherein said second machine comprises a server external to said protected network.

4. The method as claimed in claim 3 further comprising providing said e-mail message with an e-mail destination address of said external server prior to said sending, whereby said sending sends said e-mail to said external server.

5. The method as claimed in claim 4 wherein said outputting comprises sending said decoded data to a third software process on a third machine.

6. The method as claimed in claim 5 further comprising adding a third machine identifier for said third machine or for a user of said third machine to said received data prior to said encoding.

7. The method as claimed in claim 5 further comprising encrypting said received data prior to said encoding, and wherein said outputting comprises outputting encrypted decoded data.

8. The method as claimed in claim 7, further comprising decrypting said encrypted decoded data at said third machine.

9. The method as claimed in claim 7 further comprising adding a third machine identifier for said third machine or for a user of said third machine to said received data prior to said encoding, wherein said encrypting does not encrypt said third machine identifier.

10. The method as claimed in claim 5 wherein said third machine comprises a mobile terminal coupled to a digital mobile communications network, and wherein said sending of said decoded data comprises sending said data over said digital mobile communications network to said third machine address.

11. The method as claimed in claim 10 wherein said decoded data comprises e-mail data, the method further comprising employing said third software process to receive said decoded data at said third machine, process said decoded data at said third machine to convert said decoded data into a standard e-mail data format, and to make available said processed data to another software process on said third machine.

12. The method as claimed in claim 3 to for communicating data received at a plurality of said first software processes on a plurality of said first machines to said external server.

13. The method as claimed in claim 1, wherein said data for communication comprises an incoming e-mail message of an incoming e-mail for a user of said first software process.

14. The method as claimed in claim 13 wherein said outputting comprises sending said decoded data to a third software process on a third machine, and further comprising selecting said third machine dependent upon a destination address of said incoming e-mail, whereby said sending comprises sending said incoming e-mail message to said selected third machine.

15. The method as claimed in claim 14 further comprising:
receiving e-mail control data from said selected third machine at said second software process, said e-mail control data comprising data relating to a user manipulation of said incoming e-mail at a selected third machine; and
sending said e-mail control data to said first software process.

16. The method as claimed in claim 1, wherein said outputting comprises sending said decoded data to a mobile communications terminal.

17. A method of establishing a data communication link through a firewall which would otherwise block the link, without requiring a modification to said firewall, the method comprising:
establishing a first software process on a first machine;
establishing a second software process on a second machine; and
establishing said data communication link by communicating data from said first to said second software process by a methods comprising:
receiving data for communication at said first software process;
encoding said received data as an e-mail message;
sending said e-mail message including said encoded data from said first software process to said second software process through said firewall;
receiving said e-mail message including said encoded data at said second software process;
decoding said encoded data in said e-mail message using said second software process; and
outputting said decoded data from said second software process; and
wherein said receiving at said first software process, said encoding and said sending are implemented by said first software process without user intervention; and wherein said receiving at said second software process, said decoding and said outputting are implemented by said second software process without user intervention.

18. A processor control code stored in computer readable memory, comprising code configured to, when running:
implement a first software process to establish a data communication link with a second software process through a firewall which would otherwise block the link, the code comprising code to, without user intervention;
receive data for communication at said first software process;
encode said received data as an e-mail message; and
pass said e-mail message to an email handling process to send said e-mail message including said encoded data from said first software process to said second software process through said firewall.

19. The processor control code as claimed in claim 18 further comprising code to provide the e-mail message with an e-mail destination address of a server outside said firewall.

20. The processor control code as claimed in claim 19 further comprising code to add to said received data an identifier of a destination for said received data beyond said server, for encoding with said received data.

21. The processor control code as claimed in claim 20 wherein said e-mail handling process has an associated mail protocol including a definition of a valid address, and wherein said identifier has a format defining an invalid address for said protocol.

22. The processor control code as claimed in any one of claims claim 18 further comprising code for encrypting said received data prior to said encoding.

23. The processor control code as claimed in claim 22 wherein said encrypting comprises symmetric key encrypting.

24. The processor control code as claimed in claim 22, further comprising code to add to said received data an identifier of a destination for said received data beyond said server, for encoding with said received data, wherein said encrypting does not encrypt said destination identifier.

25. The processor control code as claimed in claim 18 further comprising code to, without user intervention,
receive an e-mail message including received encoded data through said firewall from said second software process;
decode said received encoded data; and
output said decoded received encoded data.

26. The processor control code as claimed in claim 18 wherein said received data for communication comprises an e-mail.

27. The processor control code as claimed in claim 26 further comprising code to add to said received data an identifier of a destination for said received data beyond said server, for encoding with said received data, wherein said encrypting does not encrypt said destination identifier, and wherein said decoded data includes e-mail manipulation data and wherein said code further comprises code to pass decoded data representing an e-mail manipulation to a or the e-mail handling process.

28. The processor control code as claimed in claim 18, wherein a carrier carries the processor control code.

29. Data communication apparatus for implementing a first software process to establish a data communication link with a second software process through a firewall which would otherwise block the link, the apparatus comprising:
program memory storing processor control code configured to implement a first software process to establish a data communication link with a second software process through a firewall which would otherwise block the link, the code comprising code to, without user intervention:
receive data for communication at said first software process;
encode said received data as an e-mail message;
and pass said e-mail message to an email handling process to send said e-mail message including said encoded data from said first software process to said second software process through said firewall;
a processor coupled to said program memory for operating in accordance with processor control code; and
a communications interface for communicating said e-mail message.

30. A method of implementing a first software process to establish a data communication link with a second software process through a firewall which would otherwise block the link, the method comprising:
receiving data for communication at said first software process;
encoding said received data as an e-mail message;
and passing said e-mail message to an e-mail handling process to send said e-mail message including said encoded data from said first software process to said second software process to said second software process through said firewall; and
wherein said receiving at said first software process, said encoding and said sending are implemented by said first software process without user intervention.

31. A processor control code stored in computer readable memory configured to, when running, implement a second software process to establish a data communication link with a first software process through a firewall which would otherwise block the link, the code comprising code to, without user intervention:
receive an e-mail message, including encoded data, from said first software process;
decode said encoded data in said e-mail message; and
output said decoded data.

32. The processor control code as claimed in claim 31 to implement said second software process on an intermediate machine, and wherein said decoded data has a destination beyond said intermediate machine specified by a destination identifier within said encoded data, and wherein said code to decode said encoded data includes code to decode said destination identifier.

33. The processor control code as claimed in claim 32 wherein said code to output said decoded data from said first software process comprises code to output said decoded data for sending to said destination.

34. The processor control code as claimed in claim 32 wherein said decoded data comprises encrypted data.

35. The processor control code as claimed in claim 32, wherein said code further comprises code to detect when a machine at said destination is ready to accept data, and wherein said output is dependent upon said detection.

36. The processor control code as claimed in claim 35 wherein said code further comprises code to queue said decoded data dependent upon said detection.

37. The processor control code as claimed in claim 32 further comprising code to implement a plurality of said second software processes for outputting data for sending to a plurality of different said destinations.

38. The processor control code as claimed in claim 31 further comprising code to:
receive data for communication at said second software process;
encode said received data as a second e-mail message; and
pass said second e-mail message to an e-mail handling process to send through said firewall to said first software process.

39. The processor control code as claimed in claim 31 wherein said decoded data comprises data for reconstructing an e-mail.

40. Processor control code as claimed in 31, wherein a carrier carries the processor control code.

41. Data communicating apparatus for implementing a second software process to establish a data communication link with a first software process through a firewall which would otherwise block the link, the apparatus comprising:
program memory storing processor control code configured to, when running, implement the second software process and, without user intervention:
receive an e-mail message, including encoded data, from said first software process;
decode said encoded data in said e-mail message; and
output said decoded data;
a processor coupled to said program memory for operating in accordance with said processor control code; and
a communications interface for receiving said e-mail message including encoding data.

42. A method of implementing a second software process to establish a data communication link with a first software process through a firewall which would otherwise block the link, the method comprising:
receiving an e-mail message, including encoded data, from said first software process;
decoding said decoded data in said e-mail message; and
outputting said decoded data.

43. (canceled)

44. Processor control code stored in computer readable memory configured to, when running, implement a third software process to establish a data communications link, via an intermediary second software process, with a first software process through a firewall which would otherwise block the link, said firewall being located between said first and second software processes, the code comprising code to:
send an identifier to said second software process;
receive data from said second software process, said received data comprising data defining an e-mail header and at least partial e-mail message data;
reconstruct an e-mail comprising said at least partial e-mail message from said received data; and
notify an e-mail user interface of the availability of said reconstructed e-mail.

45. The processor control code as claimed in claim 44 further comprising code to decrypt said received data prior to said reconstructing.

46. The processor control code as claimed in claim 45 wherein said code to decrypt said received data comprises symmetric key decryption code.

47. The processor control code as claimed in claim 44 wherein said reconstructed e-mail has a standard e-mail data format.

48. The processor control code as claimed in claim 44 wherein said third software process comprises a protocol driver.

49. The processor control code as claimed in claim 48 wherein said protocol driver is adapted for a substantially unmodified e-mail application interface.

50. A method of implementing a third software process to establish a data communications link, via an intermediary second software process, with a first software process, through a firewall which would otherwise block the link, said firewall being located between said first and second software processes the method comprising:
sending an identifier to said second software process;
receiving data from said second software process, said received data comprising data defining an e-mail header and at least partial e-mail message data;
reconstructing an e-mail comprising said at least partial e-mail message from said received data; and
notifying an e-mail user interface of the availability of said reconstructed e-mail.
